(19) United States
(12) Patent Application Publication
(10) Pub. No.: US 2024/0177058 A1
(43) Pub. Date: May 30, 2024

(54) Use of a Training Framework of a Multi-Class Model to Train a Multi-Label Model

(71) Applicant: PayPal, Inc., San Jose, CA (US)

(72) Inventor: Zehong Ma, Shanghai (CN)

(21) Appl. No.: 18/318,143

(22) Filed: May 16, 2023

(30) Foreign Application Priority Data
Nov. 30, 2022 (WO) PCT/CN2022/135657

(51) Int. Cl. G06N 20/00

(52) U.S. Cl. CPC G06N 20/00

(57) ABSTRACT

Techniques are disclosed relating to receiving, by a computer system, an unlabeled data object to be labeled using a classification model that is trained to output a probability distribution across a plurality of classes that are treated by the classification model as mutually exclusive. The technique may further include using, by the computer system, the classification model in a manner that determines a set of non-mutually-exclusive probabilities that respective ones of the plurality of classes apply to the unlabeled data object. Additionally, the technique may include labeling, by the computer system using the set of non-mutually-exclusively probabilities, the unlabeled data object.

### PRIORITY CLAIM

The present application claims priority to PCT Appl. No. PCT/CN2022/135657, entitled “USE OF A TRAINING FRAMEWORK OF A MULTI-CLASS MODEL TO TRAIN A MULTI-LABEL MODEL”, filed Nov. 30, 2022, which is incorporated by reference herein in its entirety.

### BACKGROUND

### Technical Field

Embodiments described herein are related to the field of data classification, and more particularly to techniques for training machine-learning models to generate labels for unlabeled data objects.

### Description of the Related Art

Machine-learning models may be used to determine a particular class for a given data object. Assigning a class to a data object may provide a characteristic for organizing data objects within a database. For example, a user may query a database to retrieve a set of data objects belonging to a same class. These data objects may be any suitable type of information, media, or other form of computer file that may be stored in a database. To determine the particular class for the given data object, a multi-class classification model may be used. A multi-class classification model scans text or other forms of content in the given data object and determines a respective probability that the given data object belongs each one of a set of classes that the model has been trained to identify. For example, a classification model may be trained to identify different types of scholarly articles. Such a classification model may be trained across a set of subjects such as biology, geology, chemistry, and physics. Running the classification model on a given article produces a set of four output values, each value representing a probability that the article is related to biology, geology, chemistry, or physics, with the sum of the four values representing a 100% probability. The classification model assumes the article belongs to one of the four classes.

### BRIEF DESCRIPTION OF THE DRAWINGS

The following detailed description makes reference to the accompanying drawings, which are now briefly described.

FIG. 1 illustrates a block diagram of an embodiment of a computer system for performing a classification model.

FIG. 2 shows an example of using a classification model to generate a mutually exclusive probability distribution among a plurality of classes.

FIG. 3 depicts an example of using a classification model to generate a set of non-mutually exclusive binary distributions for each of a plurality of classes.

FIG. 4 illustrates an example of an iterative training technique to train a classification model to generate a set of non-mutually exclusive binary distributions.

FIG. 5 shows an embodiment of an implementation of a training signal annealing module.

FIG. 6 depicts an embodiment of an implementation of a confidence-based masking module.

FIG. 7 illustrates an embodiment of an implementation of a consistency loss module.

FIG. 8 shows an embodiment of an implementation of a confidence scheduler.

FIG. 9 depicts a flow diagram of an embodiment of a method for performing a classification model to generate a set of non-mutually exclusive binary distributions for each of a plurality of classes.

FIG. 10 illustrates a flow diagram of an embodiment of a method for training a classification model to generate a set of non-mutually exclusive binary distributions for each of a plurality of classes.

FIG. 11 a block diagram of an embodiment of a computer system that may be used to implement one or more embodiments of the disclosed system is depicted.

### DETAILED DESCRIPTION OF EMBODIMENTS

A multi-class classification model may determine a probability distribution that a given input belongs to each one of a set of classes. The class with a highest probability may then be selected as the class for the data object. Such multi-class classification models, therefore, can be used to select a single class for the given input. As stated, assigning a particular class to a data object may be used to link the data object to other data objects with similar characteristics. Training a multi-class classification model may include providing sets of training data objects that have been assigned a class, referred to herein as “supervised learning.” The more training data objects that are provided, the more accurate the classification model may become. However, obtaining large sets of classified training data objects (e.g., data objects that have an assigned class) may be difficult and/or costly due to the need for an existing model or human resources to assign one of the set of classes that the model is to be trained to recognize, to each training data object. If tens of thousands, hundreds of thousands, or more pieces of training data objects are desired to accurately train a model, then the cost of obtaining this training data may be beyond a budget for the model's development.

Another technique for training a multi-class classification model is unsupervised data augmentation (UDA) in which unclassified data objects (data objects that have not been assigned to a class) are used. As unclassified data object may be easily obtained (no resources are needed to assign classes to each data object), UDA may be a desirable method to utilize. UDA techniques may include using a given unclassified training data object and augmenting it to create a second, altered, training data object. The augmentation includes altering the training data in such a manner that the training data object includes sufficient differences from the original data object, but would remain assigned to a same class. Accordingly, training a model using UDA includes training the model to assign a same class to the original and the augmented training data objects.

In contrast to multi-class classification, data objects may share one or more characteristics with data objects that are assigned to a different class. Revisiting the example from above, more than one of the four scholarly subjects of biology, geology, chemistry, or physics may apply to a given article. For example, biology and chemistry may frequently overlap. An article on bioluminescent animals may delve into the chemistry that causes the light emissions. Furthermore, such an article may touch on a geological make-up of the animals' habitats, and/or address the physics of how a bio-chemical reaction emits light. Accordingly, running such an article through the disclosed classification model may result in a highest probability of the article being in the biology class (e.g., 40% probability), but further indicate greater than zero probabilities (e.g., 20% each) that the article belongs in the other three classes.

Accordingly, in addition to assigning the given article to the biology class, there may be a use for assigning additional labels to the given article. These labels may not be given a same weight as the assigned class, but may enable database queries that allow for further refinement for identifying data objects in a given class within a database, as well as enable identification of data objects with similar characteristics across classes. In order to assign labels to an unlabeled data object, it may be desired to reuse an existing classification model rather that to train a new labeling model. For example, a trained classification model may have been trained over tens of thousands, hundreds of thousands, or even millions or more data objects. Training a new model to a same level could require a greater number of resources and/or time than an organization managing the database has.

As used herein a “class” refers to a singular topic that may be used to group a subset of data objects within a larger plurality of data objects. In addition, a “label” refers, as used herein, to a given one of one or more characteristics that may be used to describe a given data object. Accordingly, a given data object has one class and may have one or more additional labels.

While a scholarly article is used above (as well as some examples below) as an example for implementing the disclosed techniques, these techniques may be used in a wide variety of applications. For example, the disclosed labeling techniques may be used to identify and highlight various types of hate speech in a social media site or user forums. User-generated content that is identified as hate speech may be further labeled as derogatory, disparaging, offensive, defamatory, and the like. Such labeling may be used to identify groups of users generating comments around a common theme, thereby allowing a governance entity to take appropriate actions, if necessary. In a different example, an online service that is involved in electronic exchanges (e.g., online marketplaces, payment services, and the like) may use labeling techniques to identify various types of transactions based on entities involved (e.g., business-to-business, person-to-business, person-to-person, and so forth), types of items exchanged (e.g., goods for money, object for object, electronic file exchanges, etc.), geographic locations of the involved entities, time of day and/or dates when the exchanges occur, and the like. Such information may be used for analytical analysis to identify upgraded services to provide to users, and/or to identify transactions in which fraudulent or other illegal activity may have occurred.

The disclosed techniques may be utilized in these and other scenarios in which some form of record is stored and/or tracked (long-term or short) as a tool for associating records with similar characteristics. Adding multiple labels to a single record may allow for multiple associations for a given record, thereby enabling a data analyst to determine a plurality of different links between the various records.

Proposed techniques disclosed herein may enable use of a trained multi-class classification model for identifying one or more labels to apply to an unlabeled data object. Such a proposed technique may include a computer system receiving an unlabeled data object to be labeled. The computer system may use a classification model that is trained to output a probability distribution across a plurality of classes, to generate a first probability that the unlabeled data object belongs to a first class of the plurality of classes. The computer system may then repeat, using the classification model, the generating for remaining classes of the plurality of classes to generate a set of probabilities. This set of probabilities may then be used to apply one or more labels to the unlabeled data object.

Use of such techniques to reuse a multi-class classifier model may provide a method for labeling unlabeled data objects without training a new multi-label classifier model. Training of a new model may place an unacceptable burden on existing computer resources and additional computer resources may not be available. In addition, by reusing an existing multi-class classifier model, an acceptable level of consistency and/or accuracy for identifying labels may be achieved with a reduced level of training when compared to training a new model.

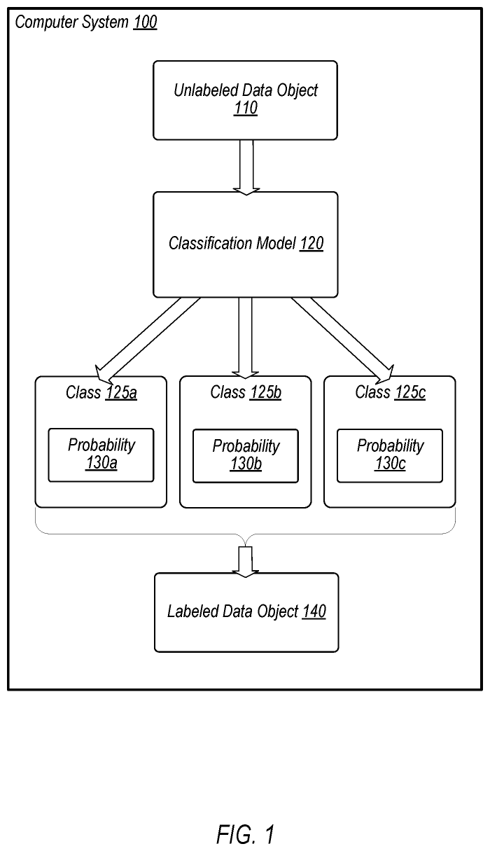

A block diagram for an embodiment of a computer system is illustrated in FIG. 1. As shown, computer system 100 includes classification model 120, which is used to identify one or more of classes 125a-125c (collectively 125) that may be applied as labels to unlabeled data object 110 to produce labeled data object 140. Computer system 100, in various embodiments, may be implemented, for example, as a single computer system, a plurality of computer systems in a data center, as a plurality of computer systems in a plurality of data centers, and other such embodiments. In some embodiments, computer system 100 may be implemented as one or more virtual computer systems hosted by one or more server computer systems. Computer system 100 may be included as part of an online service that receives and/or generates various data objects. Labels may be applied to these various data objects in order to organize, identify, group, etc., sets of the data objects.

Computer system 100 may include one or more processor circuits and a memory circuit that includes instructions that when executed by processor circuit, cause the system to perform operations described herein. As shown, computer system 100 is operable to receive unlabeled data object 110 that is to be labeled using classification model 120 that is trained to output a probability distribution across a plurality of classes 125 that are treated by classification model 120 as mutually exclusive. Classification model 120 is trained to assign a probability (also referred to herein as a “confidence level” or simply “confidence”) to each of classes 125a, 125b, and 125c that the respective one of classes 125 is the one class in which unlabeled data object 110 belongs. Accordingly, a probability distribution across classes 125 for unlabeled data object 110 may, for example, be 60% for class 125a, 30% for class 125b and 10% for class 125c, thereby indicating that unlabeled data object 110 most likely belongs in class 125a rather than classes 125b and 125c.

As illustrated, computer system 100 uses classification model 120 in a manner that determines a set of non-mutually-exclusive probabilities (e.g., probabilities 130a-130c, collectively 130) that respective ones of the plurality of classes 125 apply to unlabeled data object 110. Classification model 120, over a period of time such as months or years, may be trained using thousands or even millions of data objects. Accordingly, classification model 120 may produce confidence levels associated with classes 125 that are highly trusted by operators of computer system 100. The operators of computer system 100 may, therefore, desire to utilize classification model 120 to determine one or more labels that may be applied to unlabeled data object 110, rather than spending time and resources to create a different labeling model.

To determine probabilities 130a-130c, classification model 120, as shown, is used in a manner such that probability 130a is determined for class 125a without considerations for classes 125b or 125c. Probability 130a, therefore, may be a binary probability distribution across a positive and a negative result. For example, probability 130a may indicate a first confidence level that class 125a is associated with unlabeled data object 110 and a second confidence level that class 125a is not associated with unlabeled data object 110. In addition, probability 130a may be determined without regard for values of probabilities 130b and 130c. Similarly, probability 130b may be determined without regard for values of probabilities 130a and 130c and, likewise, probability 130c may be determined without regard for values of probabilities 130a and 130b. By isolating an instance of classification model 120 for use with ones of classes 125, a positive/negative distribution may be determined that provides a confidence that the one class applies to unlabeled data object 110. Different instances of classification model 120 may be performed serially or in an overlapping manner to generate each of probabilities 130.

As illustrated, computer system 100 labels, using probabilities 130, unlabeled data object 110. Each of probabilities 130 may be used to determine if the corresponding class 125 is to be applied as a label to unlabeled data object 110. For example, a threshold confidence may be used to determine if the positive result of each of probabilities 130 is greater than (and/or the negative result is less than) the threshold. If the positive values for probability 130a and 130c satisfy the threshold, but probability 130b does not, then classes 125a and 125c may be applied as labels to unlabeled data object 110, thereby generating labeled data object 140. Class 125b would not be applied in this example.

It is noted that computer system 100, as illustrated in FIG. 1, is merely an example. FIG. 1 has been simplified to highlight features relevant to this disclosure. In other embodiments, additional elements that are not shown may be included, and/or different numbers of the illustrated elements may be included. For example, one or more processors and/or memory circuits may be included in computer system 100 to perform and store computer instructions operable to perform classification model 120 and the operations described herein. Although three classes and corresponding probability distributions are shown, a classification model may be trained to include any suitable number of classes.

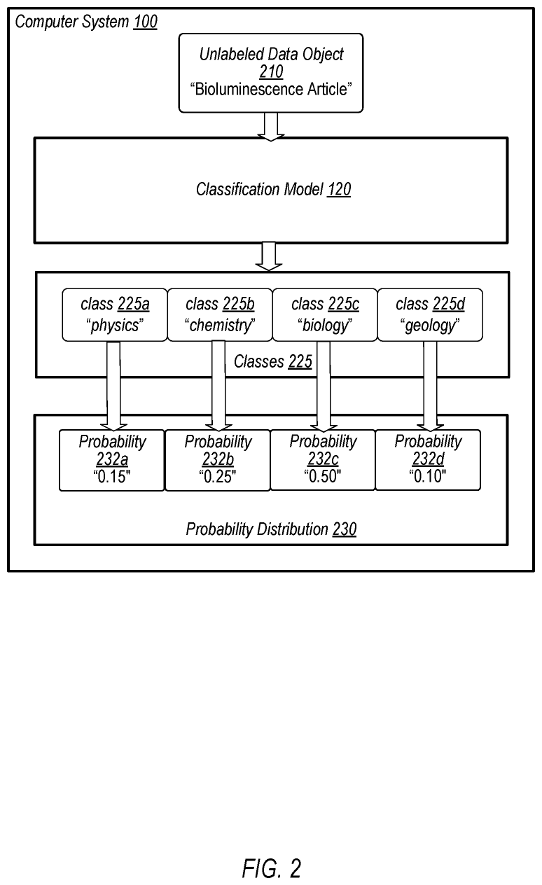

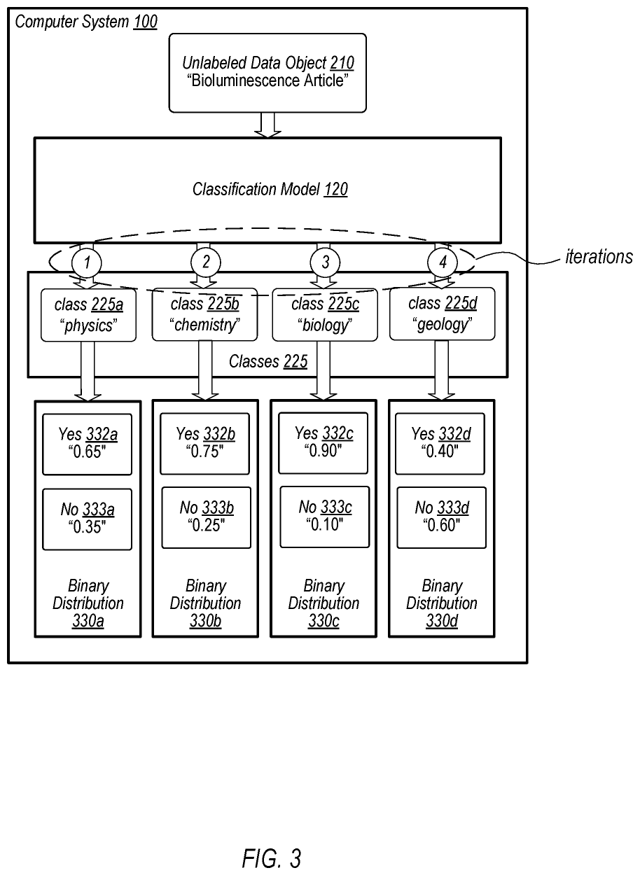

The description of FIG. 1 discloses reuse of a classification model in a manner for which the model was not initially trained. Classification models may be utilized in a variety of manners. FIGS. 2 and 3 depict two such manners as applicable to the techniques disclosed herein.

Moving to FIG. 2, an example of using a classification model to output a probability distribution across a plurality of classes that are treated by the classification model as mutually exclusive is shown. Another embodiment of computer system 100 is depicted as receiving unlabeled data object 210 and using classification model 120 to generate probability distribution 230 across classes 225.

In the illustrated example, unlabeled data object 210 is an article on the topic of bioluminescence. Classification model 120 is used to determine probability distribution 230 across four classes 225 that includes physics (class 225a), chemistry (class 225b), biology (class 225c), and geology (class 225d). Classification model 120 is trained to generate respective probabilities 232a-232d (collectively 232) for each of classes 225. For a multi-class classification, a 100% probability that unlabeled data object 210 belongs to one of the four classes 225 is distributed across the four classes 225, thereby indicating the respective probability 232 that unlabeled data object 210 belongs in the corresponding class 225. Classification model 120, therefore, has been trained to output, for a particular set of training data, probability distribution 230 across classes 225 that are treated by classification model 120 as being mutually exclusive.

As shown, classification model 120 generates a respective probability 232 for each of classes 225 with a value from zero to one. The total of probabilities 232 is one, representing a 100% probability that unlabeled data object 210 belongs to one of the four classes 225, with higher values corresponding to higher probabilities. Although a zero to one distribution is used in the present example, distributed probabilities may be determined over any suitable range. Classification model 120 determines that class 225c, biology, is a most likely class for unlabeled data object 210 with a corresponding probability 232c of 0.50. This is followed by class 225b, chemistry, with probability 232b of 0.25. Classes 225a and 225d further follow with respective probabilities 232a of 0.15 and 232d of 0.10. As described, the total for probabilities 232 is 1. Accordingly, if one of probabilities 232 were to increase in value, a total for the other probabilities 232 would decrease.

Computer system 100 may, using probabilities 232, select one of classes 225 with the highest probability to classify unlabeled data object 210 in class 225c. Such classification may be performed to organize data objects within a database for use with subsequent queries. Although a written article is used in the present example, data objects may correspond to any suitable data that are desired to be classified. For example, records associated with electronic exchanges may be classified with regard to what is exchanged and/or how the exchange is performed. Authentication attempts to a user account may be classified using a classification model based on types of data provided for authenticating, a number of failed attempts that occur before a successful attempt, and the like.

It is noted that the embodiment of FIG. 2 is merely an example to demonstrate the disclosed concepts. Although four classes are shown, any suitable number of classes may be included in other embodiments. Additional processes (not shown) may be included in some embodiments store the unlabeled data object according to the determined class.

Turning to FIG. 3, an example of using a classification model to output a binary distribution for each of a plurality of classes that are treated by the classification model as non-mutually exclusive is shown. An embodiment of computer system 100 is depicted as receiving unlabeled data object 210 and using classification model 120 to generate a plurality of binary distributions 330a-330d (collectively 330) corresponding to each of classes 225.

As described above, classification model 120 has been trained to output probability distribution 230 across classes 225 that are treated by classification model 120 as being mutually exclusive. Such training may occur over weeks, months, or even years, and may have included use of thousands or millions of data objects in the training process. With such time and resources invested in the training of classification model 120, administrators of computer system 100 may desire to reuse trained classification model 120 in a different manner to select one or more labels that may be applied to unlabeled data objects.

As illustrated, the different manner includes using classification model 120 to compare ones of classes 225 to unlabeled data object 210 over a plurality of iterations. Each iteration produces a respective one of binary distributions 330 with two respect probabilities, a yes 332 and a no 333. The Yes 332 values provide a confidence that the respective one of classes 225 applies to unlabeled data object 210, while the no 333 values provide a complementary confidence that the respective class does not apply. For example, a first iteration compares the physics class 225a to unlabeled data object 210, producing binary distribution 330a. The determined value of yes 332, 0.65, is indicative of a 65% confidence that the label of “physics” applies to the “bioluminescence article” of unlabeled data object 210. Additional iterations of classification model 120 are performed to generates binary distributions 330b, 330c, and 330d, for classes 225b, 225c, and 225d, respectively. For each iteration, results from the other iterations do not influence the confidence values of a current binary distribution. Accordingly, the 0.90 yes 332c value in binary distribution 330c does not cause the yes 332b in binary distribution 330b to be higher or lower. Classes 225b and 225c are evaluated independently. Furthermore, it is noted that some or all of the four illustrated illustrations may be performed serially, concurrently, or a combination thereof.

Computer system 100 may select one or more of classes 225 to apply as labels to unlabeled data object 210. For example, a threshold value for yes 332 may be used to select the labels, such as selecting classes 225 with yes 332 values greater than 0.51, 0.60, or any other suitable value.

In order to reuse classification model 120 in the different manner, classification model 120 is retrained, by computer system 100. This retraining includes comparing ones of classes 225 to a particular set of training data, and generating, using the comparing, a respective binary distribution 330 that indicates a confidence that a compared one of classes 225 applies, independently, to the particular set of training data. Computer system 100, as shown, evaluates whether ones of classes 225 apply to a particular training data object. e.g., within a set of training data objects. Based on these evaluations, computer system 100 generates a set of probabilities (e.g., in a manner similar to binary distributions 330) that respective ones of classes 225 apply, non-exclusively, to the particular training data object. Such a retraining of classification model 120 may utilize just a portion of the time and resources that would be required to generate a new model specifically for generating labels to apply to unlabeled data objects.

It is noted that FIG. 3 is an example to demonstrate the disclosed concepts. Only elements needed to illustrate these concepts are shown. For example, computer system 100 may include a plurality of processors and/or processor cores, such that multiple instances of classification model 120 may be performed concurrently, thereby allowing multiple iterations to be performed in parallel.

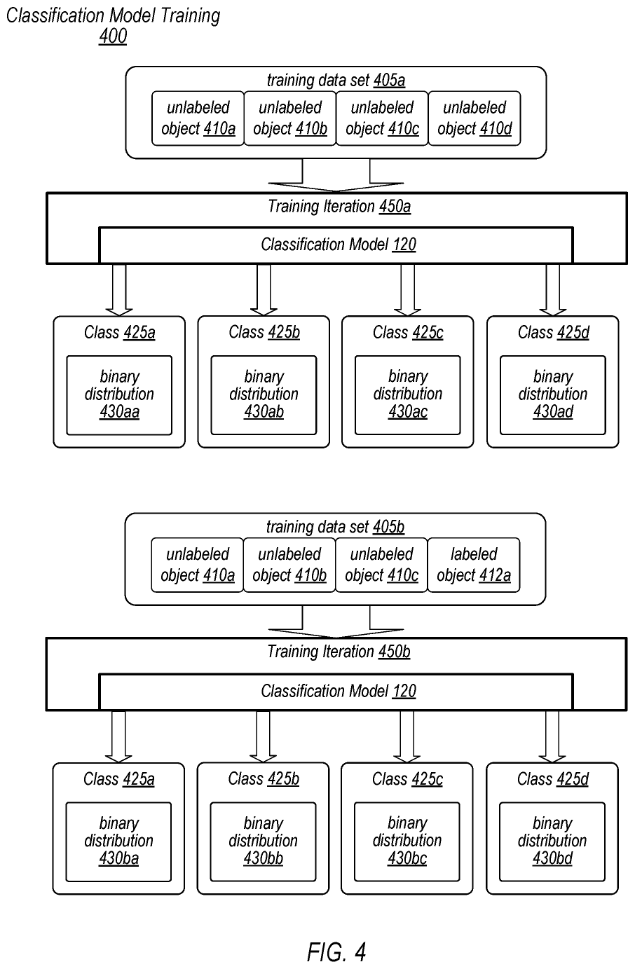

The description of FIG. 3 discloses that a classification model may be retrained in order to be used to identify potential labels for an unlabeled data object. FIGS. 4-8 depict various techniques that may be employed in order to perform the retraining.

Proceeding to FIG. 4, a block diagram of an embodiment of a technique for retraining a classification model is depicted. Classification model training 400 includes two training iterations 450a and 450b. Training iteration 450a includes using classification model 120 to generate binary distributions 430aa-430ad to indicate respective confidence levels that classes 425a-425d (collectively classes 425) apply to training data set 405a. Similarly, training iteration 450b includes using classification model 120 to generate binary distributions 430ba-430bd to indicate respective confidence levels that classes 425 apply to training data set 405b.

As illustrated, the retraining technique includes performing, by a computer system such as computer system 100 in FIGS. 1-3, a plurality of training iterations 450 using particular set of training data. This particular set of training data may include labeled and unlabeled training data objects. For example, the combination of training data sets 405a and 405b may correspond to a particular set of training data or a subset of training data. Combined, training data sets 405a and 405b include unlabeled objects 410a-410d and labeled object 412a.

Computer system 100 performs training iteration 450a using classification model 120 training data set 405a that omits labeled object 412a. Accordingly, training data set 405a includes objects that are unlabeled. Use of unlabeled objects 410a-410d may result in classification model 120 mapping classes 425 to unfamiliar input. The unfamiliar input may, in turn, prevent classification model 120 from utilizing familiar, labeled, input to map to classes 425. Instead, classification model 120 is forced to analyze terms in the unlabeled objects 410a-410d, which may include terms and/or phrases that are unfamiliar. In response, classification model 120 may begin to learn the unfamiliar input and generate a respective binary probability distribution (binary distribution) 430aa-430ad for each class of classes 425.

As shown, computer system 100 includes a subset of training data set 405a (unlabeled objects 410a-410c) and adds at least a portion of labeled training data objects (labeled object 412a) in the subsequent training iteration 450b. Adding, by computer system 100, labeled object 412a into the second, but not the first, iteration, may provide classification model 120 with known input that allows classification model 120 to either reinforce the confidence of binary distributions 430aa-430ad determined in training iteration 450a or correct the generated values in binary distributions 430ba-bd. A number of labeled training data objects included in a given training iteration 450 may be based on the respective binary probability distributions 430aa-430ad for classes 425. For example, if binary distribution 430aa satisfies a particular threshold value but binary distribution 430ab does not, then training data set 405b may include additional labeled objects 412 (not shown) when determining binary distribution 430bb that are not used when determining binary distribution 430ba. Accordingly, training data set 405b may be different for training iteration 450b when determining each of binary distributions 430ba-430bd.

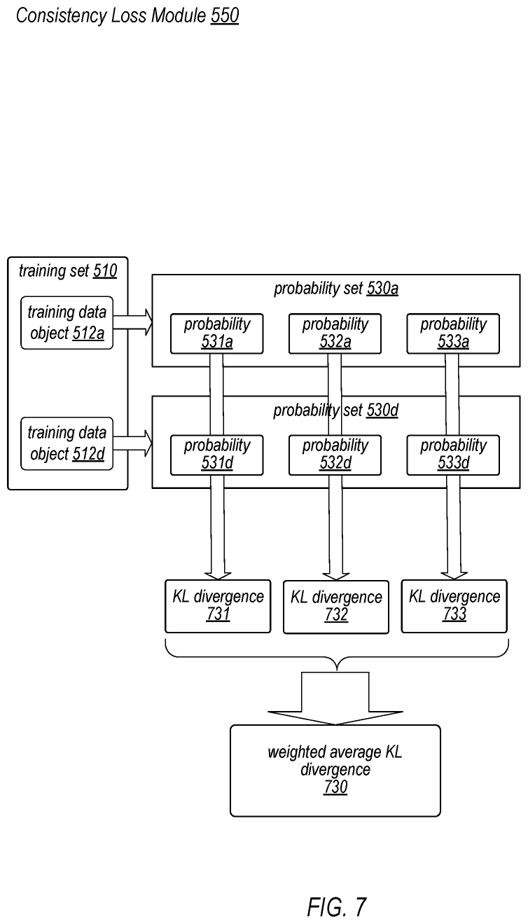

In some embodiments, computer system 100 may perform a loss calculation on the particular training data objects of training data set 405a to determine a confidence indication for binary distributions 430aa-430ad. Computer system 100 may then add, for training iteration 450b, labeled object 412a and/or other labeled objects based on this confidence indication. Confidence indications may be determined for each class of classes 425 based on the respective one of binary distributions 430aa-430ad, or may be consolidated into a single confidence indicator across all of classes 425. Additional details for determining loss calculations are presented below in regards to FIG. 7.

Completing the set of training iterations 450, in some embodiments, occurs in response to determining that a threshold number of training iterations 450 have been performed. In other embodiments, training iterations 450 continue until binary distributions 430 and/or confidence indications converge on a particular value (e.g., current results and a last result differ by less than a threshold amount). In such embodiments, a maximum number of iterations may be established to prevent an infinite loop if results don't converge on a single particular value.

It is noted that the embodiment of FIG. 4 is merely an example. Illustrated elements have been limited for clarity. Although only four training objects are shown in each training data set 405, any suitable number of objects may be included for each training iteration. Similarly, although two training iterations are illustrated, any suitable number of iterations may be performed in a retraining process.

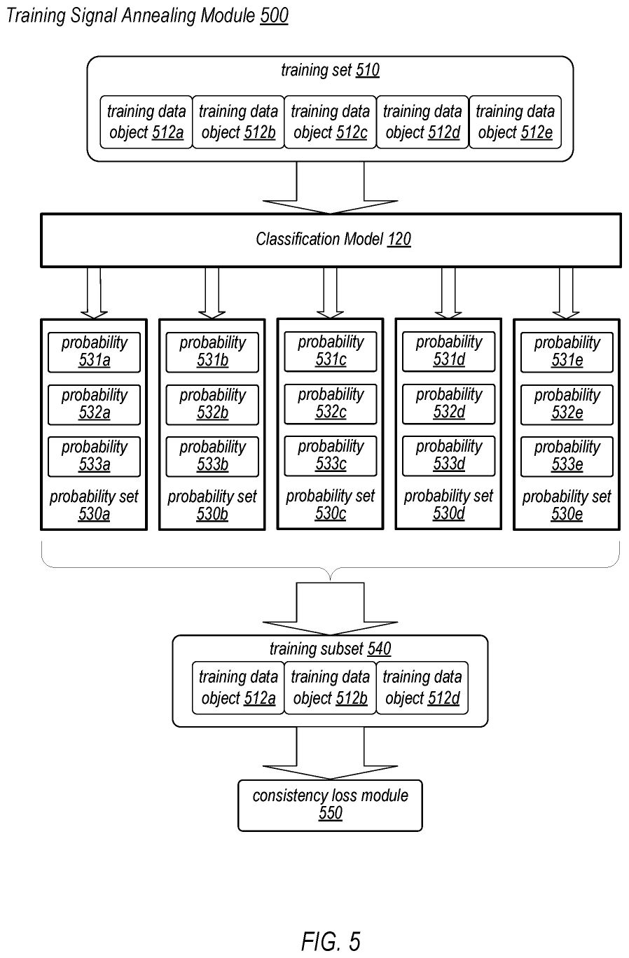

FIG. 4 describes an iterative technique for retraining a classification model. Various strategies may be utilized for performing the retraining. In FIG. 5 a training signal annealing technique is depicted.

Moving now to FIG. 5, an example of a technique used in retraining a classification model is illustrated. Training signal annealing module 500 is an example of a procedure that may be used to retrain classification model 120 to generate binary distributions for corresponding classes. Training signal annealing module 500 may be a software module performed by computer system 100.

As illustrated, computer system 100 uses training signal annealing module 500 to train classification model 120 to determine sets of non-mutually-exclusively probabilities. Training signal annealing module 500 is operable to use training set 510, with training data objects 512a-512e, as input into classification module 120. Five probability sets 530a-530e are generated, each corresponding to one training data object of training set 510. For example, probability set 530a may correspond to training data object 512a. Each of probabilities 531a-533a correspond to a binary distribution for one of a plurality of classes that classification model 120 is trained to analyze, thereby providing an indication if the respective class is applicable to training data object 512a.

After training data objects 512 have been analyzed by classification model 120 at least once, training signal annealing module 500, as shown, is operable to identify a lowest probability from a respective set of probability sets 530 associated with training data objects 512. Only probabilities that are greater than a threshold may be included in the determination of the lowest, e.g., a lowest probability that has a positive indication of a respective class corresponding to the respective training data object 512. For example, from probability set 530b, probabilities 531b and 533b may have values indicating that their respective class is applicable to training data object 512b. Probability 532b may indicate that the respective class is not applicable to training data object 512b. Accordingly, training signal annealing module 500 is operable to determine which of probabilities 531b and 533b has a lower value. This lower value is selected to represent probability set 530b. This process is repeated for each of probability sets 530.

As shown, training signal annealing module 500 is operable to determine, based on the lowest probability, whether to omit one or more of training data objects 512a-512e from consistency loss module 550. For example, probability 532c may represent probability set 530c and probability 531e may represent probability set 530e. Probabilities 532c and 531e may have higher values than the representative probabilities for probability sets 530a, 530b, and 530d. In some embodiments, probabilities 532c and 531e may both fail to satisfy a maximum threshold probability for a current training iteration. In other embodiments, training signal annealing module 500 may be operable to identify the two highest representative probabilities from the analysis of training set 510, or may be operable to identify, based on highest representative probabilities, a particular percentage of training data objects 512 from training set 510. In the illustrated example, training data objects 512c and 512e are omitted, based on probabilities 532c and 531e, from a consistency loss operation using consistency loss module 550. Accordingly, training subset 540 that is passed to consistency loss module 550 includes training data objects 512a, 512b, and 512d.

By omitting the training data objects with higher representative probabilities, classification model 120 may learn from training data that did not perform well in a certain class. By emphasizing training data with lower probabilities, classification model 120 may be better trained to resolve data imbalance issues in training data sets. Furthermore, omitting training data objects with which the model already performs well, may help to avoid issues with overfitting that may cause bias towards a particular class.

It is noted that the example of FIG. 5 is one example for demonstrating disclosed concepts. Although only three classes and five training data objects are included in the example, any suitable number of each may be included in other embodiments. In some embodiments, one iteration of training signal annealing module 500 may be performed per training set for each training iteration described in the technique of FIG. 4.

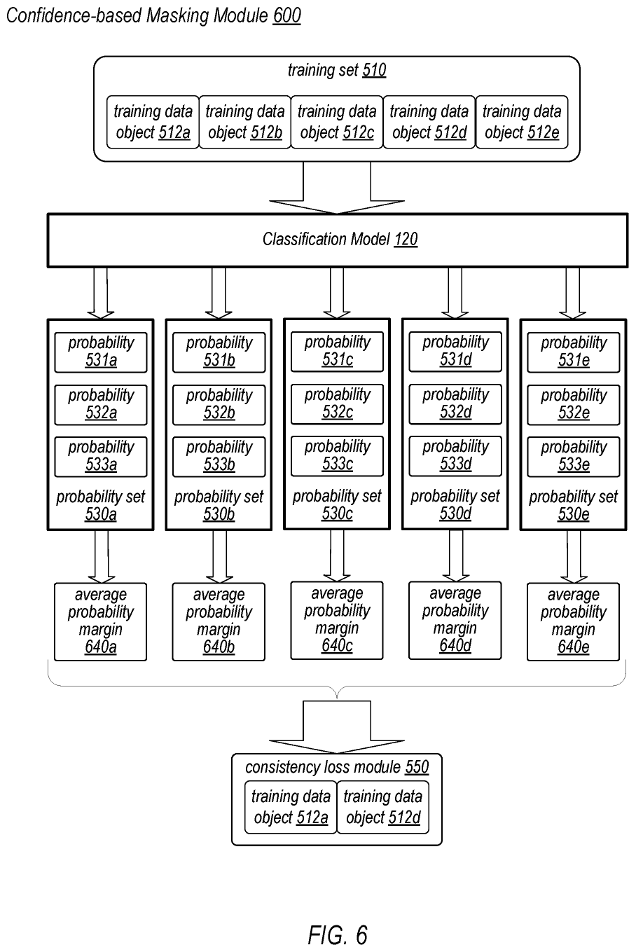

Turning now to FIG. 6, an example of another technique used in retraining a classification model is illustrated. Similar to training signal annealing module 500, confidence-based masking module 600 is an example of another procedure that may be used to retrain classification model 120 to generate binary distributions for corresponding classes. Confidence-based masking module 600 may be another software module performed by computer system 100.

In a similar manner as described for training signal annealing module 500, computer system 100 is operable to use confidence-based masking module 600 to train classification model 120 to determine a set of non-mutually-exclusively probabilities. In some embodiments, such as shown, the five probability sets 530a-530e are reused in confidence-based masking module 600. As previously described, each of probabilities 531a-533e may be a binary distribution including two values, a positive probability (a respective class applies to a respective training data object) and a negative probability (the respective class does not apply to the respective training data object).

As illustrated, using confidence-based masking module 600 includes analyzing, using classification model 120, training set 510 to determine probability sets 530. Confidence-based masking module 600 is operable to determine, for each training data object 512 in training set 510, a respective average probability margin 640a-640e (collectively 640) across the plurality of classes. A given probability margin may be determined, for example, by subtracting a lower of the two binary probabilities from a higher of the two binary probabilities. If, for example, probability 531a includes a positive value of 0.75 and a negative value of 0.25, then the probability margin is 0.75−0.25=0.5. In other embodiments, different methods may be used to determine probability margins. A probability margin is determined for each probability 531x-533x in a given one of probability sets 530, and the resulting probability margins within the given probability set 530 are averaged to produce a respective one of average probability margins 640. Average probability margins 640 may provide an indicator of how confident classification model 120 is to each class. A larger average probability margin 640 may correspond to lower entropy and more confidence in regards to the respective binary distributions.

Confidence-based masking module 600, as illustrated, is further operable to determine, based on average probability margins 640, whether to omit one or more training data objects 512 of training set 510 from a consistency loss operation using consistency loss module 550. In some embodiments, for example, only probability sets 530 for training data objects 512 whose average probability margin 640 satisfies a particular threshold may be used in a subsequent consistency loss calculation. In the current example, only training data objects 512a and 512d are used in the subsequent consistency loss calculation.

In some embodiments, confidence-based masking module 600 may be used in combination with training signal annealing module 500. While training signal annealing module 500 may omit ones of training data objects 512 with probabilities that are above a threshold, confidence-based masking module 600 may omit ones of training data objects 512 with average probability margins that are below a respective threshold, thereby establishing a window of training data objects 512 that provide sufficient confidence to perform accurate training while eliminating overconfidence that could lead to biasing of particular classes over other classes.

It is noted that FIG. 6 is another example of a technique used to train a classification model to generate non-mutually exclusive probability distributions. Although a particular method for generating probability margins is described, other methods are contemplated. In some embodiments, for example, rather than determining average probability margins, mean values may be used instead.

FIGS. 5 and 6 describe use of a consistency loss module when retraining a classification model. Consistency loss modules may be implemented in a variety of manners. FIG. 7 depicts an example implementation.

Turning now to FIG. 7, an example of a consistency loss module used in retraining a classification model is illustrated. Consistency loss module 550 may be used in combination with training signal annealing module 500 and/or confidence-based masking module 600. In a similar manner as the modules described above, consistency loss module 550 may be implemented as a software module performed by computer system 100.

As illustrated, training classification model 120 to determine a set of non-mutually-exclusively probabilities includes using consistency loss module 550. After performing training signal annealing module 500 and/or confidence-based masking module 600, training data objects 512a and 512d are identified for use in a consistency loss operation. A consistency loss operation may be used to determine how far an observed distribution is from a desired distribution. Accordingly, the consistency loss operation may be used in retraining classification model 120 to determine whether the retraining has reached a desired level of consistency when generating non-mutually exclusive probabilities for training data that has similar characteristics.

Using consistency loss module 550, as shown, includes, generating a divergence value for respective ones of the plurality of classes that are associated with training data objects 512a and 512d. In the present example, a Kullback-Leibler (KL) divergence calculation is performed across probability sets 530a and 530d for probabilities in respective classes. For example, KL divergence value 731 is based on the probability distributions 531a and 531d that are both directed to a same class. Similarly, KL divergence values 732 and 733 are determined for other respective classes.

Consistency loss module 550 further includes, as illustrated, determining a weighted average of the divergence values across all associated ones of the plurality of classes. KL divergence values 731-733 may be averaged to determine weighted average KL divergence 730. Weighting the average may be performed based on, for example, use of labeled training data objects versus unlabeled training data objects. A distribution of the labeled training data objects may be used as weights for the unlabeled data objects. Accordingly, labels used more frequently amongst the labeled training data objects are weighted higher and the less frequently used labels are weighted lower. Training data object 512a may be unlabeled while training data object 512d is labeled. Probabilities 531d, 532d, and 533d may be used in combination with similar probabilities for other labeled training data objects to establish weights for each possible outcome in a given probability set 530. Accordingly, if probability 531 is rated highly more frequently across the labeled training data objects than probabilities 532 and 533, then probability 531 may be weighted higher for training data object 512a as well as for other unlabeled training data objects. The weighted probabilities are then applied to the respective KL divergence values 731-733 to generate weighted average KL divergence 730.

In some embodiments, consistency loss module 550 may be performed one or more times per training iteration. A threshold value for weighted average KL divergence 730 may be used to determine when a given training iteration is complete and/or when the retraining itself is complete. In some embodiments, weighted average KL divergence 730 satisfying a threshold value may trigger an end to using a current training set and beginning use of a different training set within a given training iteration.

It is noted that the example of FIG. 7 is used to demonstrate disclosed techniques. Elements of the example are simplified for clarity. Although probability sets for only two training data objects are shown, any suitable number of probability sets may be included.

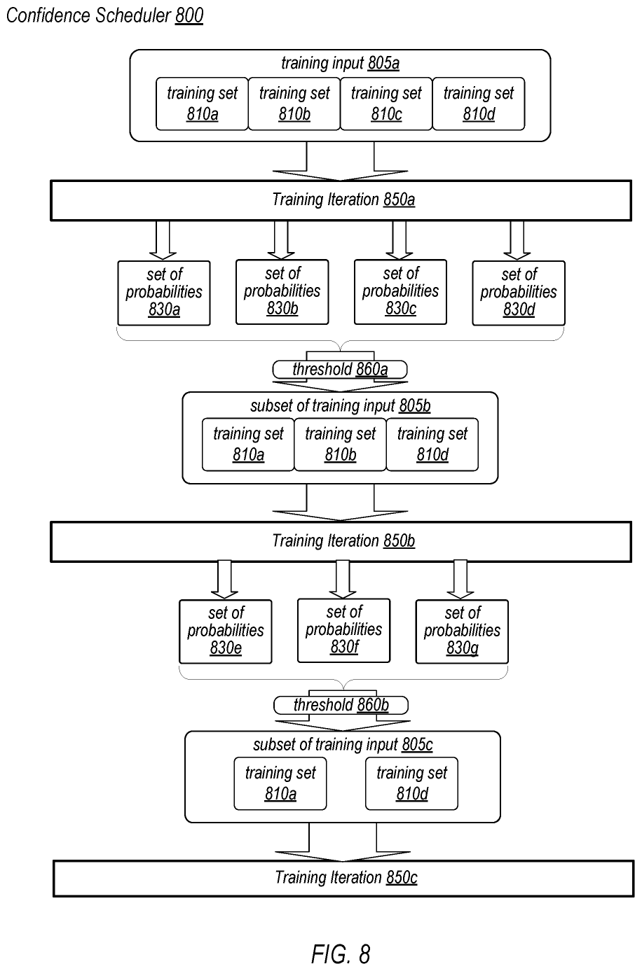

As described above, retraining a classification model may be performed using an iterative technique. Various strategies may be employed for performing subsequent iterations. An example of such a strategy is illustrated in FIG. 8.

Turning now to FIG. 8, an example of another technique used in retraining a classification model is shown. Confidence scheduler 800 may be used, in combination with any of the other techniques disclosed herein, for selecting training data to be used in subsequent training iterations. As described above regarding other modules, confidence scheduler 800 may be implemented as software performed by computer system 100.

As illustrated, computer system 100 may use confidence scheduler 800 to when training classification model 120 to determine a set of non-mutually-exclusively probabilities on training data sets 810a-810d in training input 805a. Using confidence scheduler 800 includes, after training input 805a has been analyzed in a first training iteration 850a, performing an additional training iteration 850b on subset of training input 805b. Subset of training input 805b excludes training set 810c. Analysis of training set 810c may result in set of probabilities 830c that are below threshold 860a of a set of thresholds. After subset of training input 805b has been analyzed in training iteration 850b, confidence scheduler 800 is further operable to perform a subsequent training iteration 850c on a portion of subset of training input 805b (subset of training input 805c). Subset of training input 805c excludes training set 810b from subset of training input 805b. For example, analysis of training set 810b may result in set of probabilities 830f that are below threshold 860b of the set of thresholds. Threshold 860b may be higher than threshold 860a.

Although only four training sets 810 are shown, training input 805a may include a vast amount of training sets, each training set including one or more training data objects, and each training data object including any suitable amount of data to be analyzed. Training data input may be a standard set of training data used to train a variety of models over different sets of classes. Accordingly, some training data objects included in training input 805a may be applicable to the set of classes that classification model 120 is trained to recognize, while other training data objects are not applicable to this set of classes. By excluding training data objects and/or training sets that don't include data that is applicable to at least a subset of the set of classes, training data that does not converge to desired distributions may be removed from the training process, leaving training data that may result in higher confidence levels being generated and converging to a desired distribution. By using a more stringent threshold 860 for each subsequent iteration, training data that is more applicable to the set of classes may be identified and reused in the subsequent training iterations, while less applicable training data is further omitted. This use of increasingly stringent thresholds may help to speed the retraining process to reaching a convergence on a desired distribution.

The above example describes comparison of sets of probabilities 830 to thresholds 860. In other embodiments, a confidence indication that is determined from a consistency loss operation (e.g., consistency loss module 550) may be compared to ones of the set of thresholds. In such an embodiment, the retraining may include performing a plurality of iterations on training input 805a. A given iteration may include determining an initial binary probability distribution for each class of the set of classes. Based on the initial binary probability distributions, the iteration further includes selecting a subset of the training input 805a and then performing consistency loss module 550 on the selected subset to determine a confidence indication for the binary probability distributions. The retraining may further include removing, for a subsequent iteration, training data from training input 805a that does not satisfy a first threshold value of a set of threshold values. As described above, the subsequent threshold values for additional iterations may increase (or decrease depending on how confidence indications are calculated) to increasingly omit training data that does not align to the set of classes.

As previously described in regard to FIG. 4, the retraining may be performed on training input 805a (and subsets thereof) until the confidence indications reach a particular threshold value. In some embodiments, completing the set of training iterations may correspond to determining that a particular number of iterations have been performed.

It is noted that FIG. 8 is an example of a technique that may be utilized to retrain a classification model, which has previously been trained to generate mutually exclusive probability distributions, to generate non-mutually exclusive probability distributions. For clarity. FIG. 8 is limited to three training iterations. In other embodiments, any suitable number of iterations may be performed when analyzing a particular training data set.

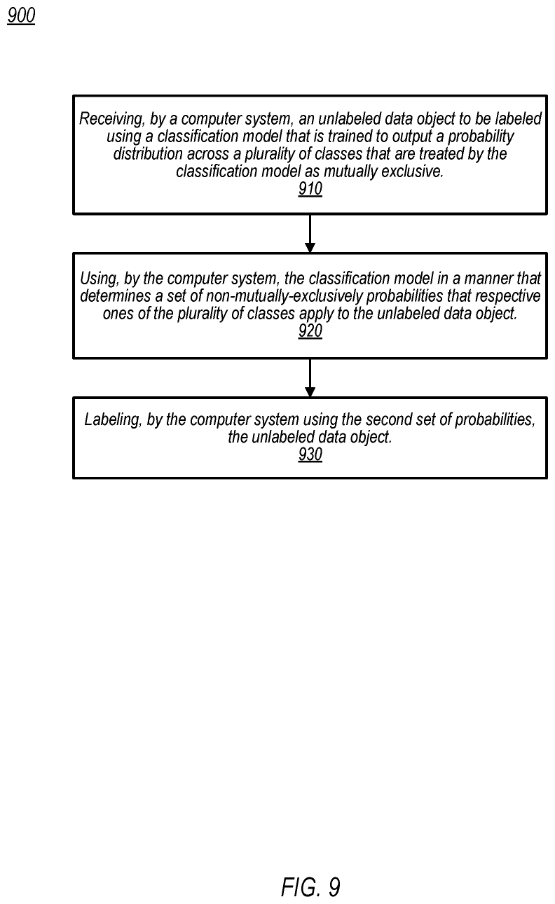

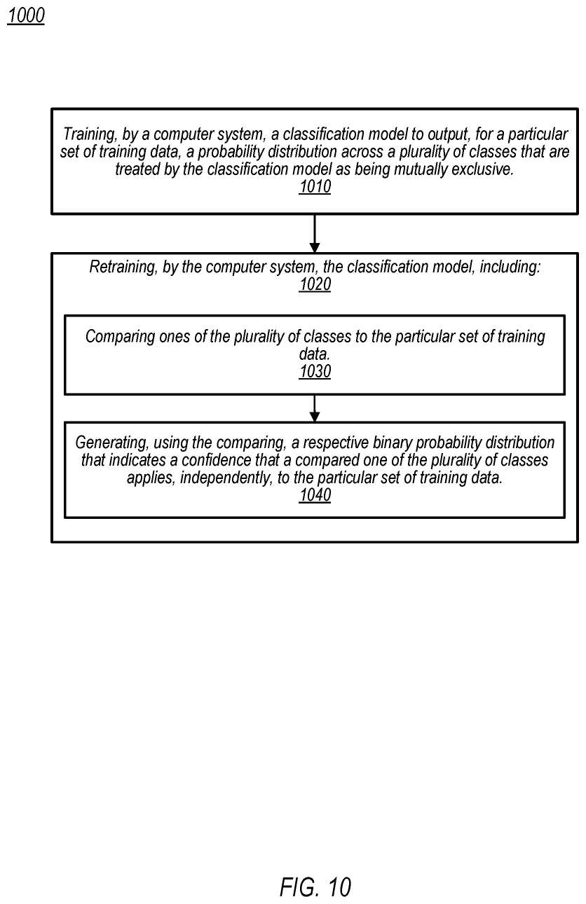

The systems described above in regard to FIGS. 1-8 may perform the disclosed techniques using a variety of methods. FIGS. 9 and 10 illustrate two example methods.

Proceeding now to FIG. 9, a flow diagram for an embodiment of a method for retraining a classification model is shown. Method 900 may be performed by a computer system such as computer system 100 in FIGS. 1-3. For example, computer system 100 may include (or have access to) a non-transient, computer-readable memory having program instructions stored thereon that are executable by computer system 100 to cause the operations described with reference to FIG. 9. Method 900 is described below using computer system 100 of FIG. 1 as an example. References to elements in FIG. 1 are included as non-limiting examples.

Method 900 begins at 910 by receiving, by a computer system, an unlabeled data object to be labeled using a classification model that is trained to output a probability distribution across a plurality of classes that are treated by the classification model as mutually exclusive. Referring to the example of FIG. 1, computer system 100 is operable to receive unlabeled data object 110 that is to be labeled using classification model 120 that is trained to output a probability distribution across a plurality of classes 125 that are treated by classification model 120 as mutually exclusive. Classification model 120 is trained to assign a probability (not shown) to each of classes 125a, 125b, and 125c. Probabilities 130 indicate a confidence that the respective one of classes 125 is the one class to which unlabeled data object 110 belongs.

Over time, classification model 120 may be trained using thousands or even millions of data objects. Accordingly, classification model 120 may produce confidence levels associated with classes 125 that are highly trusted. The operators of computer system 100 may, therefore, desire to utilize classification model 120 to determine a set of non-mutually exclusive labels that may be applied to unlabeled data object 110, rather than creating a separate labeling model.

At 920, method 900 continues by using the classification model in a manner that determines a set of non-mutually-exclusive probabilities that respective ones of the plurality of classes apply to the unlabeled data object. As illustrated in FIG. 1, computer system 100 uses classification model 120 in a manner that is different from how classification model 120 was originally trained. This different manner includes determining a set of non-mutually-exclusive probabilities 130a-130c that respective ones of the plurality of classes 125 apply to unlabeled data object 110. Probabilities 130a-130c may each include a binary distribution including a first probability that a given class applies to the unlabeled data object, and a second probability that the given class does not apply to the unlabeled data object.

Method 900 continues at 930 by labeling, by the computer system using the set of non-mutually-exclusively probabilities, the unlabeled data object, computer system 100 labels, using probabilities 130, unlabeled data object 110. Each of probabilities 130 may be used to determine if the corresponding class 125 is to be applied as a label to unlabeled data object 110. For example, a particular threshold may be used to determine if the positive values of each of probabilities 130 is greater than this particular threshold. If the positive value of a given one of probabilities 130 satisfies the particular threshold, then the corresponding one of classes 125 may be applied as a label to unlabeled data object 110. If the positive value of a given one of probabilities 130 does not satisfy the particular threshold, then the corresponding one of classes 125 may not be applied as a label.

It is noted that the method of FIG. 9 includes elements 910-930. Method 900 may end in 930 or may repeat some or all elements of the method. For example, method 900 may return to 910 to receive a new unlabeled data object. In some cases, method 900 may be performed concurrently with other instances of the method. For example, multiple instances of method 900 may be performed to concurrently process a plurality of received unlabeled data objects.

Moving to FIG. 10, a flow diagram for an embodiment of a method for retraining a classification model is shown. Method 1000 may be performed by a computer system such as computer system 100 in FIGS. 1-3. In a similar manner as described for method 900, computer system 100 may include (or have access to) a non-transient, computer-readable memory having program instructions stored thereon that are executable by computer system 100 to cause the operations described with reference to FIG. 10. Method 1000 is described below using computer system 100 of FIGS. 2 and 3 as examples. References to elements in FIGS. 2 and 3 are included as non-limiting examples.

Method 1000 begins at 1010 by training a classification model to output, for a particular set of training data, a probability distribution across a plurality of classes that are treated by the classification model as being mutually exclusive. Referring to FIG. 2, for example, classification model 120 may be trained to generate respective probabilities 232 for each of classes 225. For a multi-class classification, a 100% probability that unlabeled data object 210 belongs to one of the four classes 225 is distributed across the four classes 225, thereby indicating the respective probability 232 that unlabeled data object 210 belongs in the corresponding class 225.

At 1020, method 1000 continues by retraining the classification model using two sub-blocks, including sub-blocks 1030 and 1040, to determine a set of non-mutually-exclusively probabilities. In some embodiments, the retraining is implemented by performing a plurality of iterations using the particular set of training data. A subset of the labeled training data objects may be omitted from a first iteration. In subsequent iterations, at least a portion of the omitted subset of the labeled training data objects may be included. The plurality of iterations may include performing sub-blocks 1030 and 1040 at least once per iteration. The plurality of iterations may continue until results converge on a particular probability distribution. In some embodiments, the plurality of iterations may be limited to a maximum number of iterations, e.g., a limit determined by software.

Method 1000 continues, in 1030, by comparing ones of the plurality of classes to the particular set of training data. Computer system 100, as shown in FIG. 3, evaluates whether ones of classes 225 apply to a particular training data object, e.g., within a set of training data objects. For example, each of training data objects may be analyzed to determine if the respective training data object includes elements related to class 225a. This may be repeated for each of classes 225b-225d.

At 1040, generating, using the comparing, a respective binary probability distribution that indicates a confidence that a compared one of the plurality of classes applies, independently, to the particular set of training data. Based on the evaluations, computer system 100 generates a set of probabilities (e.g., in a manner similar to binary distributions 330) that respective ones of classes 225 apply, non-exclusively, to the particular training data object. Since a given class of classes 225 is compared to the training data objects individually, correspondence of the training data objects to a different one of classes 225 may not affect a binary distribution for the given class.

After 1040 has been performed, method 1000 may further include, at 1020 using various techniques such as training signal annealing, confidence-based masking, consistency loss operations, and/or confidence scheduling. These techniques, which are described above, may be utilized in any suitable combination to train classification model 120 to generate the non-mutually-exclusively probabilities. In an iterative embodiment, the techniques may be utilized at least once within a given iteration.

It is noted that the method of FIG. 10 includes elements 1010-1040. Method 1000 may end in 1040 or may repeat some or all elements of the method. For example, method 1000 may repeat 1030 and 1040 for a plurality of iterations, as described. In some cases, method 1000 may be performed concurrently with other instances of the method. For example, different sets of training data may be used in different instances of method 1000 in order to enable faster retraining of the classification model.

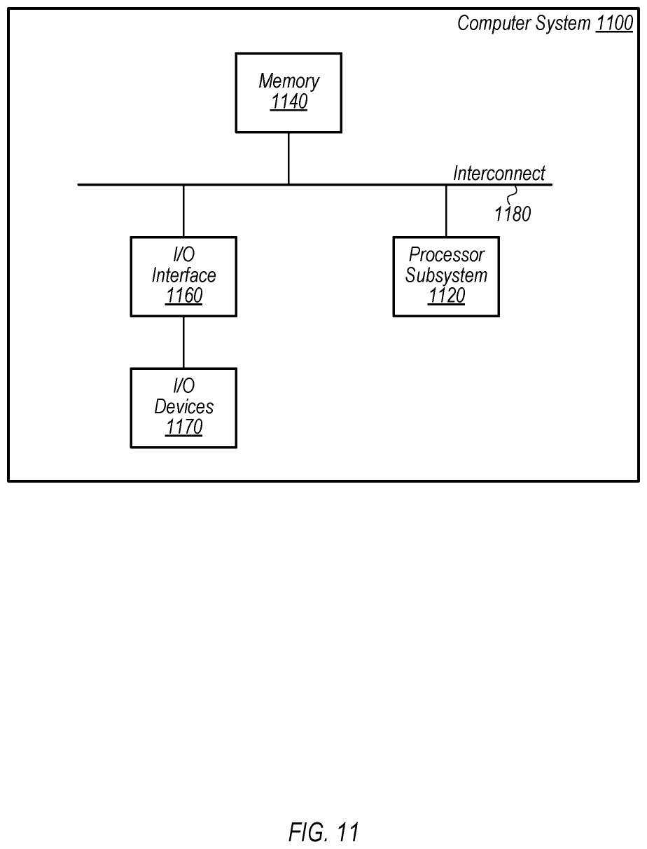

In the descriptions of FIGS. 1-10, various embodiments of a computer system for implementing the disclosed techniques have been disclosed, such as computer system 100 in FIGS. 1-3. The computer system may be implemented in a variety of manners. FIG. 11 provides an example of a computer system that may correspond to one or more of the disclosed systems.

Referring now to FIG. 11, a block diagram of an example computer system 1100 is depicted. Computer system 1100 may, in various embodiments, implement one or more of the disclosed computer systems, such as computer system 100. Computer system 1100 includes a processor subsystem 1120 that is coupled to a system memory 1140 and I/O interfaces(s) 1160 via an interconnect 1180 (e.g., a system bus). I/O interface(s) 1160 is coupled to one or more I/O devices 1170. Computer system 1100 may be any of various types of devices, including, but not limited to, a server computer system, personal computer system, desktop computer, laptop or notebook computer, mainframe computer system, server computer system operating in a datacenter facility, tablet computer, handheld computer, smartphone, workstation, network computer, connected vehicle, etc. Although a single computer system 1100 is shown in FIG. 11 for convenience, computer system 1100 may also be implemented as two or more computer systems operating together, e.g., as a virtual computer system.

Processor subsystem 1120 may include one or more processor circuits. In various embodiments of computer system 1100, multiple instances of processor subsystem 1120 may be coupled to interconnect 1180. In various embodiments, processor subsystem 1120 (or each processor unit within 1120) may contain a cache or other form of on-board memory.

System memory 1140 is usable to store program instructions executable by processor subsystem 1120 to cause computer system 1100 perform various operations described herein, including, for example, any of methods 900 and 1000. System memory 1140 may be implemented using any suitable type of memory circuits including, for example, different physical, non-transient, computer-readable media, such as hard disk storage, floppy disk storage, removable disk storage, flash memory, random access memory (RAM-SRAM, EDO RAM, SDRAM, DDR SDRAM, LPDDR SDRAM, etc.), read-only memory (PROM, EEPROM, etc.), and so on. Memory circuits in computer system 1100 are not limited to primary storage such as system memory 1140. Rather, computer system 1100 may also include other forms of storage such as cache memory in processor subsystem 1120 and secondary storage in I/O devices 1170 (e.g., a hard drive, storage array, etc.). In some embodiments, these other forms of storage may also store program instructions executable by processor subsystem 1120.

I/O interfaces 1160 may be any of various types of interfaces configured to couple to and communicate with other devices, according to various embodiments. In one embodiment, I/O interface 1160 is a bridge chip (e.g., Southbridge) from a front-side to one or more back-side buses. I/O interfaces 1160 may be coupled to one or more I/O devices 1170 via one or more corresponding buses or other interfaces. Examples of I/O devices 1170 include storage devices (hard drive, optical drive, removable flash drive, storage array, SAN, or their associated controller), network interface devices (e.g., to a local or wide-area network), or other devices (e.g., graphics, user interface devices, etc.). In one embodiment, I/O devices 1170 includes a network interface device (e.g., configured to communicate over Wi-Fi®, Bluetooth®, Ethernet, etc.), and computer system 1100 is coupled to a network via the network interface device.

The various techniques described herein may be performed by one or more computer programs. The term “program” is to be construed broadly to cover a sequence of instructions in a programming language that a computing device can execute. These programs may be written in any suitable computer language, including lower-level languages such as assembly and higher-level languages such as Python. The program may be written in a compiled language such as C or C++, or an interpreted language such as JavaScript.

Program instructions may be stored on a “computer-readable storage medium” or a “computer-readable medium” in order to facilitate execution of the program instructions by a computer system. Generally speaking, these phrases include any tangible or non-transitory storage or memory medium. The terms “tangible” and “non-transitory” are intended to exclude propagating electromagnetic signals, but not to otherwise limit the type of storage medium. Accordingly, the phrases “computer-readable storage medium” or a “computer-readable medium” are intended to cover types of storage devices that do not necessarily store information permanently (e.g., random access memory (RAM)). The term “non-transitory,” accordingly, is a limitation on the nature of the medium itself (i.e., the medium cannot be a signal) as opposed to a limitation on data storage persistency of the medium (e.g., RAM vs. ROM).

The phrases “computer-readable storage medium” and “computer-readable medium” are intended to refer to both a storage medium within a computer system as well as a removable medium such as a CD-ROM, memory stick, or portable hard drive. The phrases cover any type of volatile memory within a computer system including DRAM, DDR RAM, SRAM, EDO RAM, Rambus RAM, etc., as well as non-volatile memory such as magnetic media, e.g., a hard drive, or optical storage. The phrases are explicitly intended to cover the memory of a server that facilitates downloading of program instructions, the memories within any intermediate computer system involved in the download, as well as the memories of all destination computing devices. Still further, the phrases are intended to cover combinations of different types of memories.

In addition, a computer-readable medium or storage medium may be located in a first set of one or more computer systems in which the programs are executed, as well as in a second set of one or more computer systems which connect to the first set over a network. In the latter instance, the second set of computer systems may provide program instructions to the first set of computer systems for execution. In short, the phrases “computer-readable storage medium” and “computer-readable medium” may include two or more media that may reside in different locations, e.g., in different computers that are connected over a network.

Note that in some cases, program instructions may be stored on a storage medium but not enabled to execute in a particular computing environment. For example, a particular computing environment (e.g., a first computer system) may have a parameter set that disables program instructions that are nonetheless resident on a storage medium of the first computer system. The recitation that these stored program instructions are “capable” of being executed is intended to account for and cover this possibility. Stated another way, program instructions stored on a computer-readable medium can be said to “executable” to perform certain functionality, whether or not current software configuration parameters permit such execution. Executability means that when and if the instructions are executed, they perform the functionality in question.

The present disclosure refers to various operations that are performed in the context of instructions executed by one or more computer systems. For example, methods 900-1000 are described as, in some embodiments, being performed by computer system 100 as shown in various ones of FIGS. 1-3. In addition, various processes (e.g., classification model 120 in FIG. 1) are described as being performed by a computer system such as computer system 100 in FIGS. 1-3). Computer system 100 may include one or more computer systems included, for example, in one or more data centers (physical facilities that store data that drives enterprise computing applications and provides online services to users via, e.g., the Internet). These components, therefore, are implemented on physical structures (i.e., on computer hardware).

In general, any of the services or functionalities of a software development environment described in this disclosure can be performed by a host computing device, which is any computer system that is capable of connecting to a computer network. A given host computing device can be configured according to any known configuration of computer hardware. A typical hardware configuration includes a processor subsystem, memory, and one or more I/O devices coupled via an interconnect. A given host computing device may also be implemented as two or more computer systems operating together.

The processor subsystem of the host computing device may include one or more processor circuits or processing units. In some embodiments of the host computing device, multiple instances of a processor subsystem may be coupled to the system interconnect. The processor subsystem (or each processor unit within a processor subsystem) may contain any of various processor features known in the art, such as a cache, hardware accelerator, etc.

The system memory of the host computing device is usable to store program instructions executable by the processor subsystem to cause the host computing device to perform various operations described herein. The system memory may be implemented using different physical, non-transitory memory media, such as hard disk storage, floppy disk storage, removable disk storage, flash memory, random access memory (RAM-SRAM, EDO RAM, SDRAM, DDR SDRAM, RAMBUS RAM, etc.), read-only memory (PROM, EEPROM, etc.), and so on. Memory in the host computing device is not limited to primary storage. Rather, the host computing device may also include other forms of storage such as cache memory in the processor subsystem and secondary storage in the I/O devices (e.g., a hard drive, storage array, etc.). In some embodiments, these other forms of storage may also store program instructions executable by the processor subsystem.

The interconnect of the host computing device may connect the processor subsystem and memory with various I/O devices. One possible I/O interface is a bridge chip (e.g., Southbridge) from a front-side to one or more back-side buses. Examples of I/O devices include storage devices (hard drive, optical drive, removable flash drive, storage array, SAN, or their associated controller), network interface devices (e.g., to a computer network), or other devices (e.g., graphics, user interface devices.

The present disclosure includes references to an “embodiment” or groups of “embodiments” (e.g., “some embodiments” or “various embodiments”). Embodiments are different implementations or instances of the disclosed concepts. References to “an embodiment,” “one embodiment,” “a particular embodiment,” and the like do not necessarily refer to the same embodiment. A large number of possible embodiments are contemplated, including those specifically disclosed, as well as modifications or alternatives that fall within the spirit or scope of the disclosure.

This disclosure may discuss potential advantages that may arise from the disclosed embodiments. Not all implementations of these embodiments will necessarily manifest any or all of the potential advantages. Whether an advantage is realized for a particular implementation depends on many factors, some of which are outside the scope of this disclosure. In fact, there are a number of reasons why an implementation that falls within the scope of the claims might not exhibit some or all of any disclosed advantages. For example, a particular implementation might include other circuitry outside the scope of the disclosure that, in conjunction with one of the disclosed embodiments, negates or diminishes one or more of the disclosed advantages. Furthermore, suboptimal design execution of a particular implementation (e.g., implementation techniques or tools) could also negate or diminish disclosed advantages. Even assuming a skilled implementation, realization of advantages may still depend upon other factors such as the environmental circumstances in which the implementation is deployed. For example, inputs supplied to a particular implementation may prevent one or more problems addressed in this disclosure from arising on a particular occasion, with the result that the benefit of its solution may not be realized. Given the existence of possible factors external to this disclosure, it is expressly intended that any potential advantages described herein are not to be construed as claim limitations that must be met to demonstrate infringement. Rather, identification of such potential advantages is intended to illustrate the type(s) of improvement available to designers having the benefit of this disclosure. That such advantages are described permissively (e.g., stating that a particular advantage “may arise”) is not intended to convey doubt about whether such advantages can in fact be realized, but rather to recognize the technical reality that realization of such advantages often depends on additional factors.

Unless stated otherwise, embodiments are non-limiting. That is, the disclosed embodiments are not intended to limit the scope of claims that are drafted based on this disclosure, even where only a single example is described with respect to a particular feature. The disclosed embodiments are intended to be illustrative rather than restrictive, absent any statements in the disclosure to the contrary. The application is thus intended to permit claims covering disclosed embodiments, as well as such alternatives, modifications, and equivalents that would be apparent to a person skilled in the art having the benefit of this disclosure.

For example, features in this application may be combined in any suitable manner. Accordingly, new claims may be formulated during prosecution of this application (or an application claiming priority thereto) to any such combination of features. In particular, with reference to the appended claims, features from dependent claims may be combined with those of other dependent claims where appropriate, including claims that depend from other independent claims. Similarly, features from respective independent claims may be combined where appropriate.

Accordingly, while the appended dependent claims may be drafted such that each depends on a single other claim, additional dependencies are also contemplated. Any combinations of features in the dependent that are consistent with this disclosure are contemplated and may be claimed in this or another application. In short, combinations are not limited to those specifically enumerated in the appended claims.

Where appropriate, it is also contemplated that claims drafted in one format or statutory type (e.g., apparatus) are intended to support corresponding claims of another format or statutory type (e.g., method).

Because this disclosure is a legal document, various terms and phrases may be subject to administrative and judicial interpretation. Public notice is hereby given that the following paragraphs, as well as definitions provided throughout the disclosure, are to be used in determining how to interpret claims that are drafted based on this disclosure.

References to a singular form of an item (i.e., a noun or noun phrase preceded by “a,” “an,” or “the”) are, unless context clearly dictates otherwise, intended to mean “one or more.” Reference to “an item” in a claim thus does not, without accompanying context, preclude additional instances of the item. A “plurality” of items refers to a set of two or more of the items.

The word “may” is used herein in a permissive sense (i.e., having the potential to, being able to) and not in a mandatory sense (i.e., must).

The terms “comprising” and “including,” and forms thereof, are open-ended and mean “including, but not limited to.”

When the term “or” is used in this disclosure with respect to a list of options, it will generally be understood to be used in the inclusive sense unless the context provides otherwise. Thus, a recitation of “x or y” is equivalent to “x or y, or both,” and thus covers 1) x but not y, 2) y but not x, and 3) both x and y. On the other hand, a phrase such as “either x or y, but not both” makes clear that “or” is being used in the exclusive sense.

A recitation of “w, x, y, or z, or any combination thereof” or “at least one of . . . w, x, y, and z” is intended to cover all possibilities involving a single element up to the total number of elements in the set. For example, given the set [w, x, y, z], these phrasings cover any single element of the set (e.g., w but not x, y, or z), any two elements (e.g., w and x, but not y or z), any three elements (e.g., w, x, and y, but not z), and all four elements. The phrase “at least one of . . . w, x, y, and z” thus refers to at least one element of the set [w, x, y, z], thereby covering all possible combinations in this list of elements. This phrase is not to be interpreted to require that there is at least one instance of w, at least one instance of x, at least one instance of y, and at least one instance of z.

Various “labels” may precede nouns or noun phrases in this disclosure. Unless context provides otherwise, different labels used for a feature (e.g., “first circuit,” “second circuit,” “particular circuit,” “given circuit,” etc.) refer to different instances of the feature. Additionally, the labels “first,” “second,” and “third” when applied to a feature do not imply any type of ordering (e.g., spatial, temporal, logical, etc.), unless stated otherwise.

The phrase “based on” or is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

The phrases “in response to” and “responsive to” describe one or more factors that trigger an effect. This phrase does not foreclose the possibility that additional factors may affect or otherwise trigger the effect, either jointly with the specified factors or independent from the specified factors. That is, an effect may be solely in response to those factors, or may be in response to the specified factors as well as other, unspecified factors. Consider the phrase “perform A in response to B.” This phrase specifies that B is a factor that triggers the performance of A, or that triggers a particular result for A. This phrase does not foreclose that performing A may also be in response to some other factor, such as C. This phrase also does not foreclose that performing A may be jointly in response to B and C. This phrase is also intended to cover an embodiment in which A is performed solely in response to B. As used herein, the phrase “responsive to” is synonymous with the phrase “responsive at least in part to.” Similarly, the phrase “in response to” is synonymous with the phrase “at least in part in response to.”

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical). More specifically, this formulation is used to indicate that this structure is arranged to perform the one or more tasks during operation. A structure can be said to be “configured to” perform some task even if the structure is not currently being operated. Thus, an entity described or recited as being “configured to” perform some task refers to something physical, such as a device, circuit, a system having a processor unit and a memory storing program instructions executable to implement the task, etc. This phrase is not used herein to refer to something intangible.

In some cases, various units/circuits/components may be described herein as performing a set of task or operations. It is understood that those entities are “configured to” perform those tasks/operations, even if not specifically noted.

The term “configured to” is not intended to mean “configurable to.” An unprogrammed FPGA, for example, would not be considered to be “configured to” perform a particular function. This unprogrammed FPGA may be “configurable to” perform that function, however. After appropriate programming, the FPGA may then be said to be “configured to” perform the particular function.

For purposes of United States patent applications based on this disclosure, reciting in a claim that a structure is “configured to” perform one or more tasks is expressly intended not to invoke 35 U.S.C. § 112(f) for that claim element. Should Applicant wish to invoke Section 112(f) during prosecution of a United States patent application based on this disclosure, it will recite claim elements using the “means for” [performing a function] construct.

In this disclosure, various “modules” and “models” operable to perform designated functions are shown in the figures and described in detail (e.g., classification model 120, training signal annealing module 500, confidence-based masking module 600, consistency loss module 550, confidence scheduler 800, etc.). As used herein, a “module” refers to software or hardware that is operable to perform a specified set of operations. A module may refer to a set of software instructions that are executable by a computer system to perform the set of operations. A module may also refer to hardware that is configured to perform the set of operations. A hardware module may constitute general-purpose hardware as well as a non-transitory computer-readable medium that stores program instructions, or specialized hardware such as a customized ASIC. Accordingly, a module that is described as being “executable” to perform operations refers to a software module, while a module that is described as being “configured” to perform operations refers to a hardware module. A module that is described as “operable” to perform operations refers to a software module, a hardware module, or some combination thereof. Further, for any discussion herein that refers to a module that is “executable” to perform certain operations, it is to be understood that those operations may be implemented, in other embodiments, by a hardware module “configured” to perform the operations, and vice versa.

What is claimed is:

1. A method comprising:
receiving, by a computer system, an unlabeled data object to be labeled using a classification model that is trained to output a probability distribution across a plurality of classes that are treated by the classification model as mutually exclusive;
using, by the computer system, the classification model in a manner that determines a set of non-mutually-exclusive probabilities that respective ones of the plurality of classes apply to the unlabeled data object; and
labeling, by the computer system using the set of non-mutually-exclusively probabilities, the unlabeled data object.

2. The method of claim 1, wherein using the classification model to determine the set of non-mutually-exclusively probabilities includes determining, for each class of the plurality of classes, a binary distribution, wherein the binary distribution includes a first probability that a given class applies to the unlabeled data object, and a second probability that the given class does not apply to the unlabeled data object.

3. The method of claim 1, further comprising training the classification model to determine the set of non-mutually-exclusively probabilities by using training signal annealing.

4. The method of claim 3, wherein using training signal annealing includes, after a set of training data objects have been analyzed at least once:
identify a lowest probability from a set of probabilities associated with the set of training data objects, wherein the set includes probabilities that are greater than a threshold; and
determine, based on the lowest probability, whether to omit one or more training data objects of the set from a consistency loss operation.

5. The method of claim 1, further comprising training the classification model to determine the set of non-mutually-exclusively probabilities by using confidence-based masking.

6. The method of claim 5, further comprising wherein using confidence-based masking includes:
analyzing, using the classification model, a set of training data objects to determine a respective probability for each class;
determining, for each training data object in the set, a respective average probability margin across the plurality of classes; and
determining, based on the respective average probability margins, whether to omit one or more training data objects of the set from a consistency loss operation.

7. The method of claim 1, further comprising training the classification model to determine the set of non-mutually-exclusively probabilities by using consistency loss.

8. The method of claim 7, wherein using consistency loss includes, after a set of training data objects have been analyzed at least once:
generating a divergence value for respective ones of the plurality of classes that are associated with a set of training data objects; and
determining a weighted average of the divergence values across all associated ones of the plurality of classes.

9. The method of claim 1, further comprising training the classification model to determine the set of non-mutually-exclusively probabilities by using confidence scheduling.

10. The method of claim 9, wherein using confidence scheduling includes:
after a set of training data objects have been analyzed in a first training iteration, performing an additional training iteration on a subset of the set of training data objects, wherein the subset excludes training data objects that result in probabilities below a first threshold of a set of thresholds; and
after the set of training data objects have been analyzed in the additional training iteration, performing a subsequent training iteration on a portion of the subset of training data objects, wherein the portion excludes training data objects that result in probabilities below a second threshold of the set of thresholds, wherein the second threshold is higher than the first threshold.

11. A computer-readable, non-transient memory including instructions that when executed by a computer system within a computer network, cause the computer system to perform operations including:
training a classification model to output, for a particular set of training data, a probability distribution across a plurality of classes that are treated by the classification model as being mutually exclusive; and
retraining the classification model, including:
comparing ones of the plurality of classes to the particular set of training data; and
generating, using the comparing, a respective binary probability distribution that indicates a confidence that a compared one of the plurality of classes applies, independently, to the particular set of training data.

12. The computer-readable memory of claim 11, wherein the particular set of training data includes labeled and unlabeled training data objects; and
wherein the retraining includes:
performing a plurality of iterations using the particular set of training data;
omitting a subset of the labeled training data objects from a first iteration; and
including at least a portion of the subset of the labeled training data objects in subsequent iterations.

13. The computer-readable memory of claim 12, wherein a number of the labeled training data objects included in a given iteration is based on the respective binary probability distributions for the plurality of classes.

14. The computer-readable memory of claim 11, wherein the retraining includes performing a plurality of iterations on the particular set of training data, wherein a given iteration includes:
determining an initial binary probability distribution for each class of the plurality of classes;
selecting, based on the initial binary probability distributions, a subset of the particular set of training data;
performing a loss calculation on the selected subset to determine a confidence indication for the binary probability distributions; and
removing, for a subsequent iteration, training data objects from the particular set of training data that do not satisfy a threshold value.

15. The computer-readable memory of claim 14, wherein the retraining is performed on the particular set of training data until the confidence indication reaches a particular threshold value.

16. A system comprising:
training, by a computer system, a classification model to output a probability distribution across a plurality of classes, wherein a given output of the classification model includes a first set of probabilities that a particular training data object belongs exclusively to a respective one of the plurality of classes; and
retraining, by the computer system, the classification model to:
evaluate whether ones of the plurality of classes apply to the particular training data object; and
generate, using the evaluating, a second set of probabilities that respective ones of the plurality of classes apply, non-exclusively, to the particular training data object.

17. The system of claim 16, wherein the retraining includes performing, by the computer system, a set of training iterations.

18. The system of claim 17, wherein, the particular training data object is unlabeled, and wherein the retraining includes:
using, by the computer system, the particular training data object in a first and a second iteration of the set of iterations; and
adding, by the computer system, a different training data object that is labeled into the second, but not the first, iteration.

19. The system of claim 17, wherein a given iteration of the set of iterations includes:
determining an initial binary probability distribution for each class of the plurality of classes;
performing, by the computer system, a loss calculation on the particular training data object to determine a confidence indication for the binary probability distributions; and
adding, by the computer system for a subsequent iteration, a different training data object based on the confidence indication.

20. The system of claim 17, further comprising completing, by the computer system, the set of training iterations in response to determining that a threshold number of iterations have been performed.
